(19) United States
(12) Patent Application Publication
(10) Pub. No.: US 2025/0190870 A1
(43) Pub. Date: Jun. 12, 2025

(54) METHOD, DEVICE AND COMPUTER SYSTEM FOR MANAGING ARTIFICIAL INTELLIGENCE MODELS FOR PREDICTING SENSOR MEASUREMENTS

(71) Applicant: ATOS FRANCE, BEZONS (FR)

(72) Inventor: Yannick LECROART, La Grande Motte (FR)

(73) Assignee: ATOS FRANCE, BEZONS (FR)

(21) Appl. No.: 18/971,349

(22) Filed: Dec. 6, 2024

(30) Foreign Application Priority Data
Dec. 6, 2023 (EP) 23307148.9

(51) Int. Cl. G06N 20/00; G05B 23/02

(52) U.S. Cl. CPC G06N 20/00; G05B 23/024

(57) ABSTRACT

The method comprises the following steps, implemented by a computer system, of:
comparing (E4) predictions of measurements of a reference sensor of a group of given sensors placed in a real environment for a given time period, produced by an artificial intelligence model associated with said group of sensors, with measurements obtained for said reference sensor, using a first distance metric;
when (E5) the distance obtained is greater than a first given threshold, selecting (E6) a new reference sensor for said group from among other sensors in the group, the new reference sensor selected being associated with a smaller distance between the predictions of the artificial intelligence model and the measurements collected for the given time period,
re-training (E7) said artificial intelligence model,
evaluating (E8) said re-trained artificial intelligence model using an evaluation set comprising at least some of said obtained measurements, for which the obtained distance is greater than said first given threshold; and
in the event of a successful evaluation, making the re-trained artificial intelligence model available (E9) for deployment in the environment.

This application claims priority to European Patent Application Number 23307148.9, filed 6 Dec. 2023, the specification of which is hereby incorporated herein by reference.

### BACKGROUND OF THE INVENTION

### Field of the Invention

At least one embodiment of the invention relates to the management of artificial intelligence models trained to predict measurements collected by sensors in a production environment.

In particular, at least one embodiment of the invention applies to a fleet of data sensors deployed in a real environment and to the assignment of a given prediction model to groups of sensors of the same type.

### Description of the Related Art

The use of Artificial Intelligence (AI) in the Internet of Things (IoT) has become widespread. It is common practice today to train an AI model to predict the evolution of measurements collected by a data sensor over time, based on measurement data collected over a past time period, and then to use it to detect malfunctions in an industrial system in advance, for example a wastewater and rainwater collection network, and thus to anticipate breakdowns.

However, the supervision of an industrial system may require the deployment of a large number of data sensors of various types. For example, for a wastewater and stormwater collection network, thousands of sensors for water level, temperature, pressure, depth, etc. are placed at various points along the network. With such a fleet, it is understandable that it is not possible to associate a prediction model with every data sensor. As a result, it has become crucial to generalize AI models, that is, to associate the same AI model with multiple data sensors, in order to save storage resources, computing power and bandwidth.

Nevertheless, generalizing an AI model to a multitude of IoT sensors is complex due to multiple factors. Firstly, each sensor can generate different data in terms of format, resolution and frequency, making it difficult to create a single model which is suitable for all. Secondly, the sensors can be deployed in a variety of environments with changing conditions, requiring constant adaptation of the AI model to ensure optimal performance over time. Thirdly, computing power and memory constraints on IoT devices limit the complexity of AI models that can be run locally. Finally, the presence of bias in data from different sensors can complicate generalization, as models must be trained to take these variations into account.

In this increasingly complex context, it is understandable that manual management of AI models implemented in a supervision system for a real industrial environment has become difficult to achieve.

At least one embodiment of the invention aims to improve the situation, in particular to enable automated management of data prediction models generalized to groups of data sensors deployed in an industrial environment to be supervised.

### BRIEF SUMMARY OF THE INVENTION

According to at least one embodiment, a computer-implemented method of managing artificial intelligence models previously trained to predict an evolution of data sensor measurements comprises the steps, implemented within a computer system, of:
obtaining measurements collected during a given time period by a reference sensor of a group of data sensors of a plurality of sensors placed in a real environment,
comparing predictions of measurements of said reference sensor for the given time period, produced by one said artificial intelligence model associated with said group of sensors, with measurements obtained for said reference sensor, using a first distance metric;
when the distance obtained is greater than a first given threshold, selecting a new reference sensor for said group from among the other sensors in the group, the new reference sensor selected being associated with a smaller distance between the predictions of the artificial intelligence model and the measurements collected for the given time period,
re-training said artificial intelligence model from at least one training set formed from historical measurement data of the new reference sensor stored in a measurement data table and historical measurement predictions stored in a prediction data table,
evaluating said re-trained artificial intelligence model using an evaluation set comprising at least some of said obtained measurements, for which the obtained distance is greater than said first given threshold; and
in the event of a successful evaluation, making the re-trained artificial intelligence model available for deployment in the environment.

In a context of generalizing AI models to multiple data sensors deployed in a real environment, the method proposes a completely new and inventive approach for automatically supervising these AI models. It consists in detecting the occurrence of possible drifts and evolving AI models over time, based on the detected drifts.

In particular, the dataset used to evaluate a new version of an AI model is continuously enriched with the measurement data that the AI model has incorrectly predicted, thus ensuring that the model can be adapted to changes in environmental behavior. The retrained AI model is only made available for redeployment once it has successfully passed the evaluation phase on this enriched dataset.

The method, in one or more embodiments, is applicable to any type of real environment wherein a plurality of sensors and artificial intelligence models have been deployed to monitor its behavior. By guaranteeing an optimal level of AI model performance over time, the AI model management method helps to anticipate and even prevent malfunctions, thereby saving maintenance resources.

It is particularly suited, in at least one embodiment, to the supervision of industrial environments such as wastewater and rainwater collection networks. According to one or more embodiments, it also applies to a chemical production plant equipped with various types of sensors which monitor production conditions to guarantee safety and efficiency. These include temperature sensors to monitor the temperature of reactors and piping to ensure that chemical reactions take place under controlled conditions, pressure sensors installed in vessels and piping to detect any excess pressure that could lead to leaks or explosions, level sensors to monitor liquid levels in tanks, enabling optimum quantities of reagents to be maintained, gas detectors to detect the presence of potentially hazardous or toxic gases to ensure employee safety and regulatory compliance. flow sensors to monitor the flow of liquids and gases in pipelines, to ensure accurate mixing and chemical reactions, etc. These sensors are configured to transmit data in real time to a monitoring platform set up to trigger alerts or even stop a production line if one or more safety thresholds are exceeded.

The aforementioned method, by way of at least one embodiment, can also be applied to the supervision of a city's energy, traffic, lighting or waste management network, based on various types of sensors such as air quality, noise, movement, luminosity and presence sensors, waste container filling level detection sensors, meteorological sensors, etc., whose measurements are processed by an urban management platform.

According to one or more embodiments, the evaluation comprises the sub-steps of:
determining a performance score for the artificial intelligence model retrained with the evaluation set,
comparing the performance score with a performance score obtained by the artificial intelligence model before retraining, and
deciding that the evaluation is successful, when the performance score of the retrained model is greater than or equal to that of the previous version.

This ensures that the performance of the AI models is maintained or even improved over time.

According to one or more embodiments, the method further comprises the steps of:
obtaining, from the measurement data table, measurements collected by the reference sensor of one said group of data sensors of said plurality, for a first and a second distinct time period,
comparing the measurements collected by said reference sensor for the first and second time periods using a second distance metric;
when the distance obtained is greater than a second given threshold, selecting a new reference sensor for said group, the new reference sensor selected being associated with a smaller distance between the measurements collected for the first and second time periods,
re-training said model from at least one training set comprising at least part of the data of a measurement data history collected by the new reference sensor stored in said measurement data table and changing said group reference sensor,
searching for another group of sensors to which to assign said reference sensor, depending on a distance between data collected by a reference sensor associated with said other group and that collected by said reference sensor, and when said distance is less than a third given threshold, assigning said reference sensor to said other group.

For example, the first time period was supervised during a previous implementation of the method, and the second, more recent time period has never been supervised for the group of sensors.

According to at least one embodiment, the method can be used to supervise data from data sensors and, in particular, to detect any changes in the statistical properties of the data they measure over time. If drift is detected, the groups of sensors are adapted and the models are re-trained accordingly. This dual supervision makes it possible to adapt to changes in the real environment, and ensures that system performance is maintained over time.

According to one or more embodiments, the method comprises the steps of:
when said distance is greater than or equal to said third given threshold, creating a new group of data sensors comprising said reference sensor, training a new artificial intelligence model associated with the new group of sensors from at least one training set comprising at least part of the data of a measurement data history collected by the reference sensor, stored in said measurement data table;
once said new prediction model has been trained, evaluating the new artificial intelligence model using an evaluation set comprising at least some of said obtained measurements, for which the obtained distance is greater than said second given threshold;
in the event of a successful evaluation, making the new artificial intelligence model available for deployment in the environment.

For example, the evaluation set is that of the group of sensors to which the reference sensor belonged, to which is added, for the second time period, some of the data from the reference sensor at the origin of the detected drift.

One advantage, in at least one embodiment, is to guarantee a coherent and efficient grouping of sensors, with each group evolving dynamically according to changes in the real environment.

According to one or more embodiments, the evaluation of the new artificial intelligence model comprises the sub-steps of:
determining a performance score for the new AI model in the evaluation set,
comparing the performance score with a performance score of the artificial intelligence model of said group, and
deciding that the evaluation is successful, when the performance score of the new artificial intelligence model is greater than or equal to that of the existing artificial intelligence model.

One advantage, in at least one embodiment, is that the new AI model can only be deployed if it performs at least as well as the AI model in the group to which the reference sensor belonged.

According to one or more embodiments, the method further comprises the steps of:
obtaining information relating to the addition of a new data sensor in said real environment, comprising a history of measurements collected by said sensor,
searching for a group of sensors among said groups, to which to assign the new data sensor, depending on a distance between data collected by a reference sensor associated with one said group and that collected by said new sensor,
when said distance is less than a given third threshold, assigning said new sensor to said group, and
when said distance is greater than or equal to said third given threshold, creating a new group of data sensors comprising said new sensor as a reference sensor,
training a new artificial intelligence model associated with the new group of sensors,
once said new prediction model has been trained, evaluating the new artificial intelligence model using an evaluation set comprising at least some of said obtained measurements, for which the obtained distance is greater than said second given threshold,
in the event of a successful evaluation, making the new artificial intelligence model available for deployment in the environment.

One advantage, in at least one embodiment, is that the system can automatically take a new sensor into account.

For example, the evaluation set is that of a group of sensors of the same type, to which part of the data from the new data sensor is added for the second time period.

According to one or more embodiments, the method comprises a step of reading a governance computer file, stored in memory, describing for said groups of sensors, the artificial intelligence models associated with said groups, the reference sensor and operational parameters for controlling operations performed during the implementation of said steps.

By grouping all this information in a single data file, which is read before the method triggers model management operations, by way of at least one embodiment, the method has simplified access to the information it needs to run. Another advantage, in at least one embodiment, is that it can be modified without having to modify the source code of the method, tools, modules and/or applications implemented.

According to one or more embodiments, the method comprises the step of updating the governance computer file when changes have been made to said groups of sensors.

According to one more embodiments, this update relates to an identifier of a new reference sensor in an existing group, a new group of sensors and an associated AI model, etc. One advantage is to ensure that complete, reliable and up-to-date information is available for execution.

According to one or more embodiments, the method comprises the step of generating an event report comprising information relating to operations performed during the implementation of said steps and making it available.

In this way, a user in charge of monitoring the automated operation of the system can know the sequences of actions implemented. Reports can also be used to automatically generate a dashboard comprising one or more key indicators describing the performance of the computer system.

According to at least one embodiment of the invention, a device for managing artificial intelligence models previously trained to predict an evolution of data sensor measurements comprises the following means, implemented within a computer system, of:
obtaining measurements collected during a given time period by a reference sensor of a group of data sensors of a plurality of sensors placed in a real environment,
comparing predictions of measurements of said reference sensor for the given time period, produced by one said artificial intelligence model associated with said group of sensors, with measurements obtained for said reference sensor, using a first distance metric,
when the distance obtained is greater than a first given threshold, selecting a new reference sensor for said group from among the other sensors in the group, the new reference sensor selected being associated with a smaller distance between the predictions of the artificial intelligence model and the measurements collected for the given time period,
re-training said artificial intelligence model from at least one training set formed from historical measurement data of the new reference sensor stored in a measurement data table and historical measurement predictions stored in a prediction data table,
evaluating said re-trained artificial intelligence model using an evaluation set comprising at least some of said obtained measurements, for which the obtained distance is greater than said first given threshold; and
in the event of a successful evaluation, making the re-trained artificial intelligence model available for deployment in the environment.

According to one or more embodiments, the device comprises:
at least one processor; and
at least one memory comprising computer program code, the at least one memory and the computer program code being configured to, together with the at least one processor, cause said device to be run.

According to one or more exemplary embodiments, the aforementioned device is configured to implement the method according to one or more embodiments of the invention.

Correlatively, according to at least one embodiment, the aforementioned device is integrated into a computer system for managing prediction models comprising:
at least one data registry storing artificial intelligence models previously trained to predict data sensor measurements for a next time period, based on data collected for a previous time period,
at least one data warehouse comprising a data table, comprising a history of measurement data collected by the data sensors, and a data table comprising a history of predictions of sensor measurements by said artificial intelligence models,
at least one memory storing a governance computer file describing the groups of sensors, and for one said group of sensors, the prediction model, the measurement data table and operational parameters controlling operations performed by said device.

At least one embodiment of the invention also relates to a computer program product comprising instructions for executing the aforementioned method.

Finally, at least one embodiment of the invention relates to a non-volatile computer-readable recording medium whereupon the aforementioned computer program is recorded.

The device, computer system, computer program product and recording medium provide at least the same advantages as the method according to at least one embodiment of the invention.

Of course, the one or more embodiments described above can be combined with one another.

### BRIEF DESCRIPTION OF THE DRAWINGS

The one or more embodiments will be better understood in light of the following detailed description and accompanying drawings, which are given by way of illustration only and therefore do not limit the disclosure.

FIG. 1 shows an overall schematic view of a system for managing a plurality of artificial intelligence models, according to one or more embodiments of the invention.

FIG. 2 shows an example of a governance computer file, according to one or more embodiments of the invention.

FIG. 3 shows a flowchart of steps in a method for managing a plurality of artificial intelligence models previously trained to predict measurements collected by data sensors, corresponding to operation of the system shown in FIG. 1, enabling a drift in the predictions of said models to be corrected, according to one or more embodiments of the invention.

FIG. 4 shows a flowchart of additional method steps for correcting a drift in the observations measured by one said data sensor, according to one or more embodiments of the invention.

FIG. 5 shows a flowchart of additional method steps to take account of an additional data sensor, according to one or more embodiments of the invention.

FIG. 6 schematically shows an example of the hardware structure of a device for accessing information contained in data tables, according to one or more embodiments of the invention.

### DETAILED DESCRIPTION OF THE INVENTION

The specific structural and functional details described herein are non-limiting examples. The one or more embodiments described herein are subject to various modifications and alternative forms. The subject matter of the disclosure may be embodied in many different forms and shall not be construed as being limited to the only embodiments presented herein as illustrative examples. It should be understood that there is no intention to limit the one or more embodiments to the particular forms described in the remainder of this document.

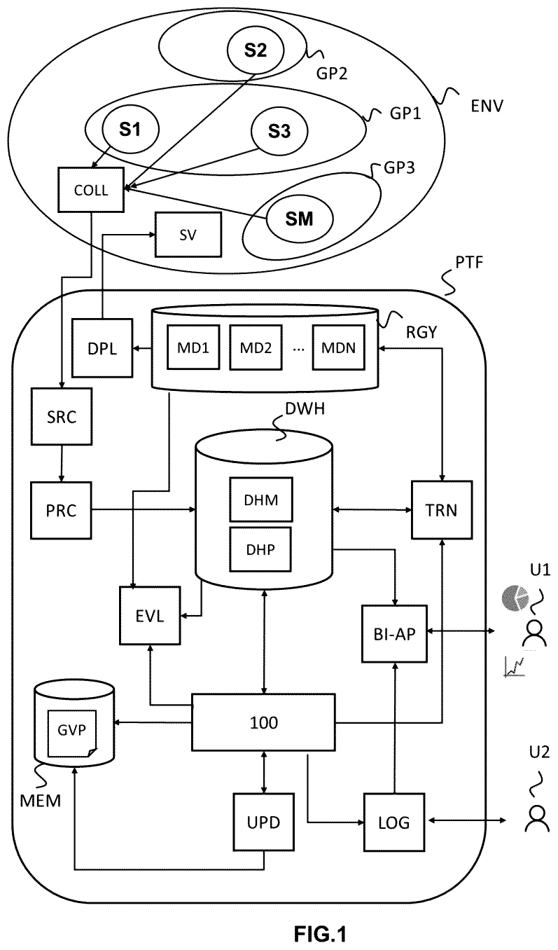

FIG. 1, according to one or more embodiments of the invention, shows the overall architecture of a system or platform PTF for managing a set of AI models MD1, MD2, . . . MDN, with N a non-zero integer, previously trained to predict, for a future time period, the evolution of measurements done by data sensors S1, S2, . . . SM, with M a non-zero integer, placed in a real environment ENV, based on observations or measurements done by these data sensors for a given time period. For example, the sensor measurements are collected by a collector COLL. For example, for the wastewater and stormwater collection network mentioned above, the future time period considered may be a quarter of an hour, half an hour, an hour, etc. As for the past time period, this may vary depending on the application. For the previous example, it can be at least as long as the future time period.

The AI models in question can be of various types, including, by way of purely illustrative examples, convolutional neural networks (CNNs), recurrent neural networks (RNNs), decision trees, linear regression models, etc. These models are trained in a supervised manner, using a history of sensor measurement data stored in memory.

According to this architecture, by way of at least one embodiment, the data sensors are grouped into a plurality of groups GP₁ to GP_{N}, generally by type. We note that they can also be grouped according to common statistical properties of the measurement data time series which they collect, each group GPᵢ being associated with a given AI model MDᵢ. In other words, the same AI model MDᵢ is implemented to predict a temporal evolution of the measurement data from all the sensors in the group GPᵢ.

The system PTF comprises multiple components that interact with each other to enable these AI models to be managed, and in particular to be maintained and upgraded.

The system PTF comprises at least one memory wherein one or more versions of the AI models, MD₁ to MD_{N}, are stored. One example is the model registry RGY. In the context of artificial intelligence, this term refers to a module or system for centrally storing, organizing and managing AI models. Model registries are often used in environments shared by multiple teams working on AI projects, and they play a crucial role in the model lifecycle. In particular, they enable different versions of AI models to be stored centrally. This makes it easy to search, retrieve and manage models. They also facilitate the management of different versions of a model, recording changes made, hyperparameters used, associated datasets, etc. This ensures model traceability, which is essential for understanding a model's evolution over time. In a collaborative environment, multiple teams or researchers may be working on similar or related models. A model registry enables more efficient collaboration by avoiding conflicts, sharing results and ensuring the consistency of models used in different projects. By recording all the information needed to reproduce a model (source code, data, hyperparameters, etc.), a model registry facilitates the reproducibility of experiments and results. These model registries can also offer integrated deployment functionalities, making it easy to deploy a trained model to production environments. Additionally, they can include features to monitor model performance in production, collecting metrics such as precision, recall, etc. Finally, they can integrate authorization management mechanisms, enabling control over who can access, modify or deploy a specific model.

In short, a model registry simplifies the management, monitoring and collaboration around AI models, contributing to more efficient use of resources and better quality of results. It is an important tool in the development and deployment of AI-based applications, particularly in complex environments where multiple teams interact.

The system PTF also includes a source module SRC configured to obtain observation or measurement data from the plurality of data sensors S1, S2, . . . , SM in the environment ENV, for example via the collector COLL. For example, these measurement data take the form of time series. The frequency of IoT sensor data collection depends largely on the application context, specific system requirements and operational constraints. These include the nature of the data, constraints linked to the energy consumption of the sensors, which may be battery-powered, their storage capacity, constraints linked to the nature of the events monitored, data transmission cost constraints (for example, pricing may be based on the volume of data transmitted for certain communication networks), etc. A prior analysis of the specific needs of the application and the implementation of pilot tests help determine the optimum frequency of data collection. In many cases, flexibility is important, and IoT systems can be configured to dynamically adjust collection frequency to changing conditions or specific needs. For example, wastewater and rainwater collection network sensors collect an average of one measurement per minute. They are then aggregated to the quarter-hour to reduce the size of the historical measurement data recorded per sensor.

The system PTF also includes a data processing module PRC configured to access source data obtained from data sensors by the module SRC and perform one or more processes on this data, and a loading module for loading the processed data into a data table DHM stored in a data warehouse DWH BI of the system PTF, for example a relational database. The data table DHM groups together all the observations measured by sensors S1 to SM, or measurement history, since they were commissioned in the environment ENV.

For example, the processing carried out by the module PRC may include cleaning and/or filtering source data to eliminate noise and artifacts, reformatting and/or transcoding data to make it compatible with a known repository of the platform PTF. Processing IoT sensor data to remove anomalies, biases and noise is a crucial step in guaranteeing the quality and reliability of the information obtained. The following non-exhaustive processing can be applied:
Data filtering (digital filtering): digital filters can be used to attenuate noise in sensor signals. Low-pass, high-pass or band-pass filters can be adapted to suit the characteristics of the signal and the type of noise present,
Averaging and smoothing: the application of averaging techniques can help smooth out random fluctuations in the data. This can be useful for noise attenuation, particularly in situations where minor variations are not significant,
Outlier detection: outlier detection techniques, such as statistical outlier detection or the use of AI algorithms, can be used to identify and eliminate anomalous data that may result from faulty sensors, measurement errors or other sources of disturbance. This can be achieved by taking advantage of measurements from multiple sensors of related types, such as a water level sensor and a depth sensor, and comparing their measurements to detect any inconsistencies,
Correcting systematic errors (bias): systematic errors, such as sensor bias, can be identified and corrected by calibrating the sensors or applying appropriate corrections to the data,
Interpolation: interpolation can be used to replace missing data or outliers with estimates based on surrounding data. This can help provide more complete and consistent data sets,
Feature transformation: certain feature transformations, such as normalization, standardization or logarithmic transformation, can be applied to make data more suitable for statistical analysis and reduce bias effects.

Once processed by the module PRC, the measurement data are used to generate data tables ready for use in the management of AI models MD₁ to MD_{N} by the system PTF, in particular their training and evaluation. To do this, they are built in accordance with a database schema, defined according to the company's needs, which describes the tables, relationships between data tables, primary and foreign keys, and other integrity constraints on the data they contain. In this way, the data table DHM is structured in such a way that it can be used to extract input data for presentation to one of the AI models, as well as label data representative of reality on the ground. These input data and their associated labels are generally grouped together to form learning or training, test and evaluation datasets, as disclosed below.

In this example, by way of at least one embodiment, the data table DHM comprises at least the following columns:
date of measurement,
measurement,
sensor identifier
sensor group identifier.

This is of course only an illustrative and non-limiting example, and other organizations may be considered, according to one or more embodiments of the invention.

In an application example, in at least one embodiment, the real environment ENV is an industrial environment, such as a wastewater and stormwater collection network. Thousands of data sensors are placed throughout the network to measure physical properties such as temperature, pressure, water level, etc., over successive time periods. In this example of applications, the aim of using AI models is to automatically obtain predictions of an evolution of these different measurements for a future period, from which a malfunction can be predicted and anticipated. For example, blockages can occur when a tree root obstructs a pipe. This situation can be highly problematic, for example when wastewater is superimposed on stormwater and overflows into the environment, leading to soil pollution. In this example, the temperature, pressure and water level measurements collected over time by the plurality of data sensors are received by the system PTF, processed and then stored in the data table DHM. This data history is intended to be used for training the AI models MD1 to MDN and for their evaluation by the system PTF.

The system PTF also comprises a module TRN for training AI models using a training dataset built up for each group GPᵢ from the measurement data of a given sensor in that group, stored in the measurement data table DHM. This module is configured to implement an initial learning phase, followed by regular re-training phases once the AI model has been put into production in the environment ENV.

The system PTF also comprises a module EVL for evaluating AI models once the learning phase (training or retraining) has been completed. It is based, for each AI model, on an evaluation dataset that also comprises measurement data from one of the group's sensors and associated labels. Of course, to avoid any bias, the sets used for learning and evaluation are separate. It should be noted that evaluation sets are generally set up upstream of the project, that is, before the initial phase of training and deployment of AI models. For example, such a set comprises measurements collected by a sensor of the group over the entire history. The purpose of the evaluation module is to check that the AI model just trained is sufficiently efficient, that is, that it predicts the measurements of the group's sensors well enough to be deployed. In particular, when it comes to replacing a previous version of the AI model already in production with a new version, the module EVL is configured to check that the new version of the AI model is at least as good as the previous version, before it is deployed.

The system PTF also comprises a module DPL for provisioning and deploying AI models once they have been trained and evaluated. The term “provisioning” refers to the storage and/or transmission of AI models ready for deployment, and the term “deployment” refers to the commissioning of a model in the production environment ENV. This module DPL is, for example, connected to a communication module (not shown) of the system PTF, via which the AI model is transmitted to a data server SV of the environment ENV, configured to use it to predict sensor measurements for a next time period from data collected for a previous time period. In this respect, the data server SV comprises at least one memory for storing AI models MD₁ to MD_{N} and at least one processor for executing them. In at least one embodiment, the AI models are deployed at a remote host and connected to the local server SV via a telecommunications network (not shown). In this case, AI models are run on remote servers, for example in a server farm, or as a service accessible via a cloud computing network.

The system PTF further comprises a device 100 for managing artificial intelligence models MD1, MD2, . . . , MDN trained to predict measurements collected by the plurality of sensors placed in the real environment ENV, said prediction models being stored in the memory of the computer system PTF, for example in the model registry RGY, the device 100 being configured to obtain measurements collected by a reference sensor from a group of at least one of said data sensors, for a past time period, said so-called historical measurements being stored in the data table DHM, obtain predicted measurements from said reference sensor using one said prediction model associated with said group of sensors for a subsequent time period, said predicted measurements being stored in a prediction history data table DHP of the data warehouse DWH, compare the predicted measurements for the next time period with measurements collected by said reference sensor for the next time period, when a determined difference between the compared measurements is greater than a given prediction drift threshold, select a new reference sensor for said group, the newly selected reference sensor being the data sensor of said group associated with the smallest difference, and re-train the AI model from the historical measurement data collected by the new reference sensor.

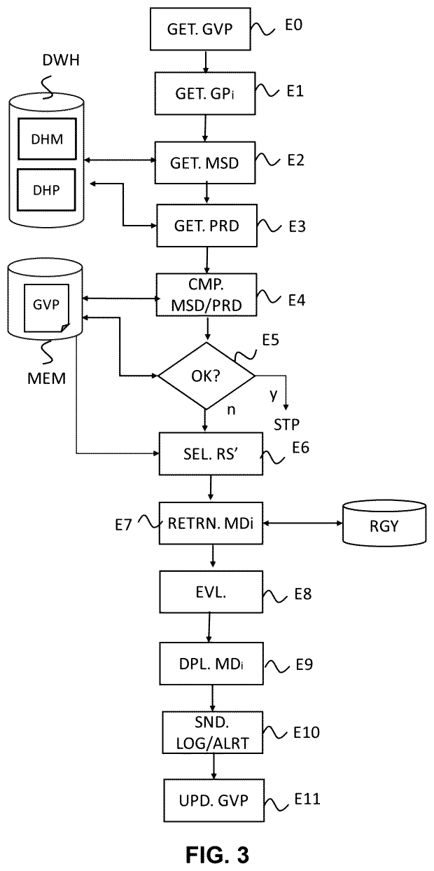

According to one or more embodiments, the device 100 implements a method for managing artificial intelligence models MD1, MD2 . . . MDN, which will be disclosed below in relation to FIG. 3.

The system PTF also comprises a module LOG for creating and transmitting reports or event logs wherein, in particular, any detected cases of drift are recorded. The event reports generated can also be used by an application BI-APP to generate dashboards containing KPIs (Key Performance Indicators) relating to the operation of the system PTF and/or the AI models it manages.

The system PTF also comprises user interface means, not shown, enabling a user U1, for example a data scientist, to obtain these dashboards.

A central control module, not shown, comprising one or more processors controls the operation of the various components of the system PTF.

The system PTF can be owned by a company responsible for monitoring the environment ENV, such as a water authority, and hosted on site, or alternatively, it can be hosted remotely, for example in a public cloud.

The system PTF is implemented using hardware means and software means. Hardware means may comprise one or more processors. Software means may comprise applications, software, computer programs, and/or a set of program instructions and data.

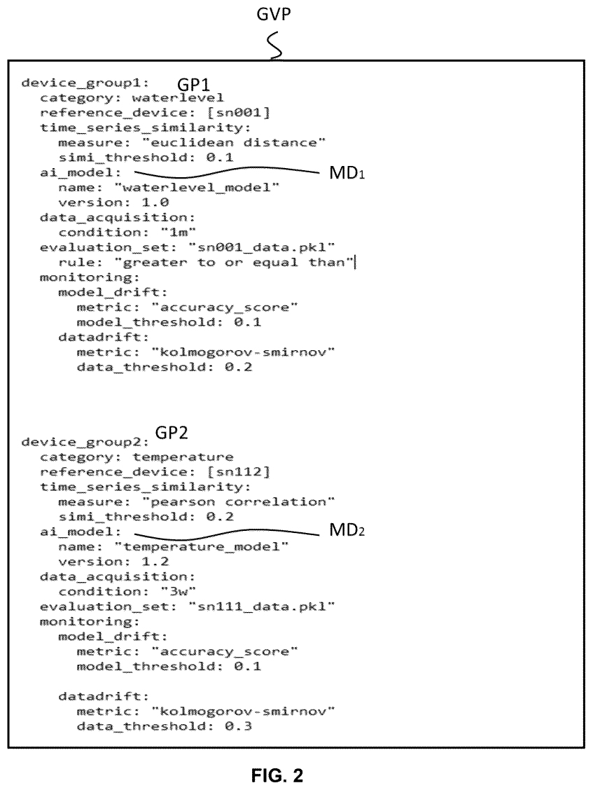

According to one or more embodiments, the system PTF also comprises an update module or agent UPD configured to update data stored in memory and required for operation of the system PTF. This includes configuration data, for example specifying a similarity measure, a drift threshold, the reference sensor for each group of data sensors, etc. An example is now detailed in relation to FIG. 2, according to one or more embodiments of the invention.

In at least one embodiment, the system PTF comprises a governance and/or configuration computer file GVP, stored in memory MEM. This computer file may be a declarative file, for example of the CSV, YAML, XML or other type. A purely illustrative example of a governance file GVP is shown in FIG. 2, according to one or more embodiments of the invention. It contains information relating to the groups GP₁, GP₂, . . . , GP_{N}, with N a non-zero integer, of data sensors, in the example shown in FIG. 2, GP₁ and GP₂, comprising for each group a sensor category or type, the identifier(s) (not shown) of all the sensors making up this group, the identifier(s) of the reference data sensor(s) for this group, that is, the data sensor(s) whose measurement data will be used to manage the plurality of AI models. It also comprises an identifier and version number for the AI model associated with the group. It also describes operational parameters for controlling operations of the system PTF, for use by entities of the system PTF, and in particular the device 100, to execute various operations. For example, group GP₁ comprises two sensors sn001 and sn002 belonging to the “water level” category. The associated AI model MD₁ is a “water level model” and version 1.0 is used. The group GP₂ also comprises two data sensors sn111 and sn112 of the temperature sensor type. The AI model active in production is a temperature model in version 1.2.

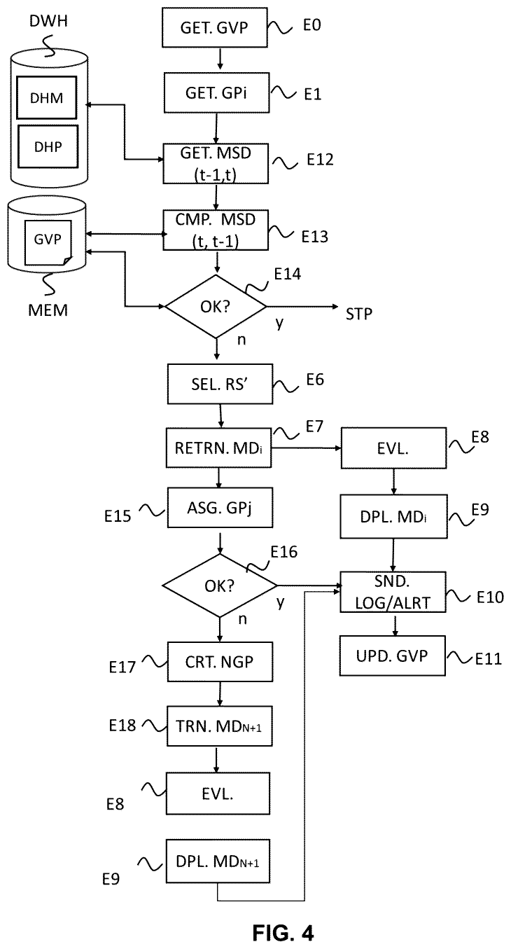

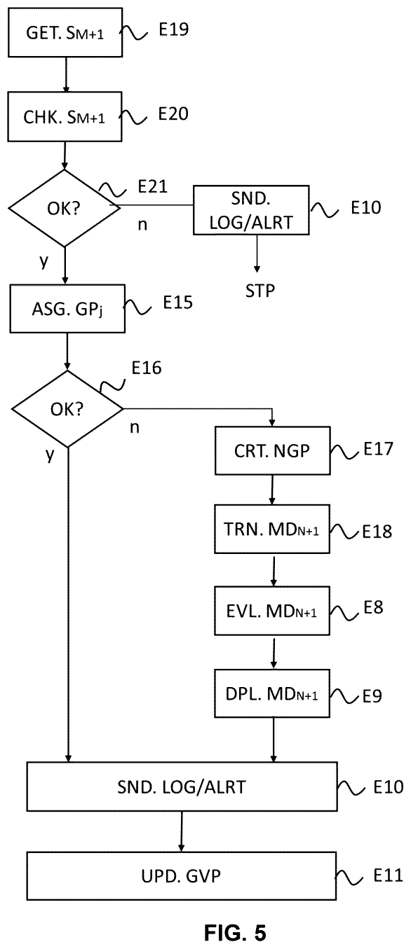

As an illustrative and non-limiting example, by way of at least one embodiment, the governance file GVP specifies:
one or more parameters relating to the acquisition of historical measurement data by the data sensors of the group. In particular, it specifies a minimum duration of data acquisition, that is, an age, and as a result, a volume of data required for a data sensor to be included in this group. Of course, this condition depends on the type of data measured by the sensor. It is understood that a condition of duration greater than one year makes it possible to capture any seasonality in the measurements collected, particularly when the measurements are linked to nature and weather conditions. For example, for the first group GP₁, it is three years (“3 y”), while for the second group GP₂, it is one year (“1 y”).
operational parameters intended for use by the device 100 in one or more embodiments and/or by one or more modules of the system PTF. In particular, they comprise conditions, rules and metrics intended to be used by the device 100 to supervise an AI model in production and detect any drift in its performance. For example, for the first group GP₁, the metric to be used to compare the AI model's predictions for a given time period with the measurements actually collected by a sensor in the group GP₁ is a metric representing the model's accuracy-score, and the drift threshold is set at 0.1 (above this threshold, it is decided that the model is drifting). According to at least one embodiment, which will be detailed below in relation to FIG. 4, these are also operational parameters intended to be used by the device 100 to detect a drift in the data measured by one or more data sensors. In this case, the operational parameters indicate a metric to be used to measure a similarity between measurement data collected by the sensor over a past time period and that collected over a current time period, and an associated drift threshold. For example, for the first group GP₁, the metric to be used is “Komogorov-Smirnov” metric and the associated drift threshold is 0.2. According to at least one embodiment, these are operational parameters intended to be used by the module TRN of the system PTF to evaluate an AI model after training and before putting it into production. An example will be detailed below in connection with FIG. 5, according to one or more embodiments of the invention, in the context of adding an additional data sensor to the fleet of sensors deployed in the environment ENV. In particular, they specify the location of an evaluation or test dataset, different from the training dataset to avoid bias, and a prediction performance threshold. For example, for the first group GP₁, the test dataset is stored in the location indicated by the relative, not absolute, path “sn111-data.pkl”. The .pkl extension is associated with a Python computer code file saved in “Pickle” format. Pickle is a standard Python module for serializing and deserializing Python objects. In other words, it allows Python objects (for example AI models and training or evaluation datasets) to be saved in a file in binary format using Pickle, and then later allows these objects to be loaded from the file for reuse in a computer program without having to re-train it.

In the example of group GP₁, the specified performance threshold is 0.95. In other words, a level of performance is considered to be acceptable (and the AI model can be put into production) from a score equal to the performance threshold of a similarity measure, such as Jaccard's index, a drift threshold, a first weight associated with the KPI and a second weight associated with the keywords. An example of these operational parameters will be detailed below in relation to FIG. 3, according to one or more embodiments of the invention.

During operation, each element of the system PTF, and in particular the device 100, can access the file GVP and read the operational parameters therein for controlling the operation or task to be implemented.

The file GVP can be modified, making it possible to change the data sensors making up a group of sensors, the version of the AI model used and/or the operational parameters of the system PTF and, in particular, the device 100, without having to modify the source code enabling the system PTF to perform tasks and operations.

The central control module (not shown) is arranged to control the operation of the system PTF. It may comprise a task orchestrator for scheduling the tasks executed by the system PTF.

We will now describe a method for managing a plurality of AI models MD1 to MDN, stored in the model registry RGY of the system PTF shown in FIG. 1, corresponding to the operation of the device 100, according to one or more embodiments and with reference to FIGS. 3 to 5. In the example shown in FIG. 3, by way of at least one embodiment, described in particular is the supervision of an artificial intelligence model of a given group of sensors.

In step E0, the governance file GVP is read, enabling the device 100 to obtain the latest version of the operational parameters it stores.

In step E1, information about a group GPᵢ, where i is between 1 and N, of data sensors to be processed is obtained. For example, it is assumed that the different groups of data sensors are processed in turn by the management method, in a given, for example predetermined, order, which ensures that the operation of each one is checked regularly. For example, the supervision of a group of sensors is triggered once a month, the group of sensors to be supervised being chosen randomly or according to a given order.

According to one or more embodiments, it may be the orchestrator that instructs the device 100 to supervise a given group. In the following, we take the example of the group GP1 of water level sensors shown in FIG. 2, by way of at least one embodiment. Using the governance file GVP, a reference data sensor RS associated with group GPᵢ is identified among the sensors attached to group GPᵢ, along with an AI model MDᵢ associated with that group i. It is assumed that it is in production in the environment ENV, and that the historical prediction data table DHP stored in the warehouse DWH is supplied on an ongoing basis with the data that the model MDᵢ predicts from the data measured by the reference sensor RS.

In a step E2, measurement data collected by this reference sensor Sm over a given time period, corresponding for example to last month, is obtained from the historical data table DHM stored in the data warehouse DWH. For example, the given time period corresponds to the period since the model MDᵢ was last supervised. For example, its value is one or more months. In this respect, it is advisable to dissociate a frequency of prediction of the measurements of the sensor group GPi by the AI model MDi, for example, every quarter of an hour, from a frequency of supervision of the AI models by the device 100, for example, every month.

In a step E3, the data predicted for the same time period by the model MDi is obtained from the data table DHP, which comprises the prediction history of this model. In this respect, sensor measurements can be collected by the collector COLL at a given collection frequency, for example every quarter of an hour, and then transmitted to the AI model management system PTF at a different transmission frequency, for example once a month.

In step E4, the measurement data obtained in E2 is compared with the predicted data obtained in E3. It is understood that the aim is to compare time series data and evaluate a measurement of distance/similarity between them.

According to one or more embodiments, this distance is obtained using one or more distance determination techniques, including, by way of purely illustrative and non-limiting example, the following techniques:
a temporal correlation technique measures the similarity between two time series by examining the correlation between observations at different points in time. High correlation suggests temporal similarity. However, it does not capture any time shifts.
a Euclidean distance measurement measures the geometric distance between points in two time series. One advantage of this measurement is that it is simple to calculate, but it is not robust to time lags or scale differences.
a Dynamic Time Warping (DTW) technique, which measures the similarity between two time series by finding an optimal mapping between points while allowing for time shifts. It has the advantage of being robust to time shifts, but is costly in terms of computing resources.
a pattern-based similarity measurement consists in identifying and comparing patterns in time series. It may involve the use of frequent pattern search algorithms or specific pattern detection techniques.
Fourier series decomposition can be used to extract frequency components from time series, and similarity can be assessed by comparing frequency components.
Methods based on AI models such as ARIMA models, recurrent neural networks (RNNs) or Long Short Term Memory (LSTMs) are also known. RNNs are better suited to dealing with long-term dependencies and can be used for temporal data, and similarity can be measured by comparing model parameters.
machine learning methods, such as classification or regression methods, can be used to predict a sequence of values from an input sequence, and similarity can be measured by comparing predictive performance.

A combination of these techniques can also be used, depending on the nature of the data. The technique(s) to be used, for example, is (are) specified in the governance file among the operational parameters associated with the sensor group GPi and the supervision task in question. In this case, the operation carried out is a monitoring operation. In the example shown in FIG. 2, for group GP1, the measure of accuracy or distance considered is an “accuracy score”.

It is assumed that a similarity score is obtained, which is compared in E5 with a model performance threshold (in FIG. 2, “model_threshold”), also specified in the governance file GVP. If the score obtained is greater than or equal to the performance threshold, the AI model is considered compliant (no drift detected) and the method stops. According to one or more embodiments, an event report is generated by the module LOG and made available.

If, conversely, the score obtained is below the threshold, the AI model MDi is not considered compliant (a drift has been detected).

In response, a corrective action is implemented. In step E6, a new reference sensor is searched for within the group. To do this, the measurement data and associated predicted data for the time period under consideration are obtained for the sensors in the group other than the current reference sensor, and the one with the best model performance score is selected to become the new reference sensor RS′ for this group.

In E7, a retraining phase of the AI model MDᵢ is triggered at the module TRN, based on a training set formed from part of the historical measurement data associated with the new reference sensor stored in the data table DHM. At the end of this re-training phase, it is tested using a test set, separate from the learning set.

In this respect, by way of at least one embodiment, there are multiple ways of dividing the historical measurement data to form these two distinct data sets, including, but not limited to, the following:
random division: the simplest method is to randomly split the data set into a training set and a test set. For example, 80% of the data could be reserved for learning and 20% for testing,
stratified division: when the classes in a classification problem are not balanced, it may make sense to use stratified division to ensure that the distribution of classes is maintained in the training and test sets
time division: for time series, it is often necessary to respect the chronological order of the data. In this case, the division can be done using a specific time window, using past data for learning and future data for testing.
cross-validation: rather than dividing the data into a single training and test set, cross-validation involves dividing the data into multiple sets, thus enabling the model to be trained and tested on different training/test combinations. “K-fold” cross-validation is a common method where the data is divided into k folds, and the model is trained and tested k times, each fold being used as a test set exactly once.

In E8, once the AI model MDᵢ has been retrained, an evaluation of the retrained model is triggered in the module EVL using a third data set, the so-called evaluation set.

Generally, according to the prior art, this evaluation set is created upstream, that is, when the sensor group is set up, by an analyst for example, and is not intended to be modified subsequently. The path to this evaluation set is pre-configured, for example in the governance file GVP.

A performance score is evaluated and compared with that obtained by the previous version of the model MDᵢ (currently in production). A decision rule, for example specified in the governance file GVP, is to replace the previous version of the AI model with the new one as soon as the new version achieves a performance score at least as good as that of the previous version.

According to one or more embodiments, the method disclosed herein comprises the prior updating of the evaluation set stored in memory by adding thereto some of the measurement data (and associated labels) collected by the former reference sensor RS and for which a model drift has been detected. In this way, it is ensured that new versions of the AI models deployed keep pace with the evolution of measurements, and therefore continuously adapt to the environment to be supervised.

In this respect, one constraint to be respected when setting up the training and test sets of the AI model MDᵢ is not to integrate sensor measurements from the group GPᵢ that are already present in the evaluation set. Respecting this constraint avoids introducing a bias in the comparative evaluation of the performance of the new version of the AI model with the previous one.

In the following, it is assumed that the new version of the model MDᵢ has successfully passed the evaluation. In E9, the new version of the model MDᵢ is put into production in place of the current version. For example, it is transmitted by the deployment module DPL of the system PTF to the server SV of the environment via the communication means of the system PTF, then loaded into a memory in place of the previous version for execution by a processor of a data server. Alternatively, in one or more embodiments, it can be transmitted to a remote server in the environment ENV, hosted in a cloud network-type infrastructure. For example, this new version is transmitted to the server in question in a file in Pickle format.

Note that if, conversely, the new version of the AI model does not pass the evaluation test, the version of the AI model in production remains unchanged. However, an event report LOG is generated so that an analyst in charge of monitoring the system PTF is informed of this failure and can determine whether an update of other modules is required. For example, he may decide to modify the processes implemented on the measurement data by the module PRC, or the configuration parameters of the AI model itself.

Optionally, in E10, an event report LOG is created, stored in memory and possibly notified to a user UT2, for example an analyst in charge of maintaining the system PTF.

In step E11, an update of the governance file GVP is triggered at the update agent UPD. It comprises updating the version of the model MDᵢ, and the identifier of the new reference sensor RS′.

The method disclosed above, by way of one or more embodiments, supervises AI models deployed in a real environment and implements corrective actions in the event of a detected drift in the performance of one of these models.

In relation to FIG. 4, we now disclose additional method steps for supervising the data measured by the sensors, according to one or more embodiments of the invention. They can be carried out following the previous steps or upstream, for the same group of sensors or for another one, according to a given order and rhythm, which can be determined based on the real environment ENV, in particular the nature of the physical quantities measured by the data sensors and their propensity to evolve over time. For example, the data supervision which will now be disclosed according to this other embodiment is carried out alternately with that (of the models) previously presented in relation to FIG. 3, according to one or more embodiments of the invention.

Steps E0 for reading the governance file GVP and E1 for obtaining a group of sensors GPᵢ, already disclosed, are repeated. For example, it is assumed that the selected group of sensors GPⱼ, with j different from i, is not the same in this new supervision phase as in the one disclosed in relation to FIG. 3, according to one or more embodiments of the invention, and applies to the group GP₂ of FIG. 2, according to one or more embodiments of the invention. From the governance file GVP, an identifier of the reference sensor RS is obtained for group GPⱼ. In the example shown in FIG. 2, in at least one embodiment, the reference sensor for group GP2 has the identifier “sn112”.

In a step E12, measurement data collected by the reference sensor RS, for two distinct time periods, are obtained from the historical data table DHM for group GPⱼ. The two time periods may or may not be consecutive. Since the aim is to detect whether or not the reference sensor's measurements have retained the same statistical properties, it may be appropriate to consider a first recent or current time period, for example the previous hour, day, week or month, and a second, slightly older time period, for example the hour, day, week or month prior to the first period.

In E13, the measurements collected by said reference sensor RS for the two time periods are compared, using a given distance metric, for example that specified by the governance file GVP for detecting data drift in relation to the group of sensors GPⱼ under consideration. In the example shown in FIG. 2, for group GP₂, the “Kolmogorov-Smirnov” metric or test is used. This statistical test, known per se, is used to quantify a difference or distance between the distribution functions of real-world data, as in this case, the time series of data from a sensor over two distinct time periods.

In E14, it is determined whether the distance obtained is greater than a given drift threshold. For example, this threshold was previously obtained from the governance file GVP. In the example shown in FIG. 2, in at least one embodiment, the data threshold (“data_threshold” in the example of FIG. 2) is set at 0.3. If not, it is decided that there is no drift in the measurement data from the reference sensor RS and the method stops. The device 100 performs no operation and waits to re-execute a next AI model or data supervision phase.

On the contrary, when the distance between the compared measurements is greater than the drift threshold, a new reference sensor RS′ is selected for said group, in a new execution of step E6 already disclosed. The new reference sensor RS′ selected is the one associated with the smallest distance calculated using the previous metric. Next, the model MDⱼ is re-trained, and then tested in a new execution of step E7 already disclosed in relation to FIG. 3, in at least one embodiment, using a training data set and a test data set each comprising part of the historical measurement data stored for the new reference sensor RS′. In this respect, it should be noted that when setting up these training and test sets, it is first verified that the measurement data extracted from the data table DHM (particularly for the most recent time period) has not already been integrated into the evaluation set, to avoid introducing bias into the training (training and test) and evaluation sets.

In step E15, a search is done for another group of the N groups of sensors to which to assign the reference sensor RS which has just been replaced. The most suitable group of sensors is selected based on the similarity between the historical measurement data stored in memory for this sensor and that of the reference sensors in the other sensor groups. To do this, the metric used is the one specified in the governance file for each of the other groups considered. For example, by way of one or more embodiments, for group GP₁, this is the Euclidean distance. At this stage, at least the following two cases are considered:
1. The sensor's measurement data are sufficiently similar to those of a reference sensor in another group, according to a test performed in E16 in compliance with the similarity threshold “simi_threshold” specified in the governance file GVP) and the group change is executed,
2. Conversely, no sensor group has been found whose reference sensor is sufficiently close. In this case, a new group GP_{N+1} is created for it in E16. A new AI model MD_{N+1} is assigned to it, whose training by the module TRN is triggered in E18. Once training is complete, the new model MD_{N+1} is evaluated in E8 and then deployed in E9 (put into production) in the environment ENV as disclosed above.

For this new model MD_{N+1}, it is assumed that no evaluation set has been established in advance. In this case, it is envisaged to use the evaluation set previously used for the group GPⱼ from which the old reference sensor RS originates, which is enriched with at least some of the measurements of the reference sensor RS for which a data drift has been detected in E14. During the evaluation in E8, a performance score for the new model MD_{N+1} is compared with a performance score for the model MDi of the group GPⱼ to which the reference sensor RS was previously attached. The model MD_{N+1} is then deemed to have successfully passed the evaluation if its performance score is at least equal to that of the model MDiᵢ. This ensures that the creation of the new group GP_{N+1} has no negative impact on system performance.

In both cases, steps E10 to generate and transmit an event report LOG and E11 to update the governance file GVP are triggered. In the first case, this update comprises at least the updating of information data relating to the group GPⱼ that has been supervised: new reference sensor identifier RS′, and new version of the AI model.

Additionally, in at least one embodiment, information about the sensor group into which the old reference sensor RS has been integrated is updated, comprising the identifier of this additional sensor.

In the second case, in at least one embodiment, the information and operational parameters associated with the new group GP_{N+1} are added, including the identifier of the old reference sensor RS, which is in fact the reference sensor for this new group, the identifier of the new AI model MD_{N+1}, and the path to the new evaluation set associated with this new group. For example, this evaluation set is automatically formed from part of the measurement data history of the sensor RS, which has not been used to form the training and test sets.

The steps disclosed above involve supervising the measurement data collected by the reference sensor of a group of sensors placed in the environment ENV, by way of one or more embodiments. They help to detect any drift, for example due to the occurrence of a new behavior in the environment ENV, such as the presence of a new climatic or other phenomenon.

Referring to FIG. 5, described now is the use of a new data sensor S_{M+1} according to one or more embodiments of the invention. It is assumed to have been added to the fleet of data sensors deployed in the environment ENV.

In step E19, information about the addition of the additional data sensor S_{M+1} to the environment ENV is obtained. The device 100 can obtain this information in various ways. For example, it receives a notification from the control module or the orchestrator of the system PTF. Such a notification comprises at least one identifier of the added sensor S_{M+1}. It can also comprise a link to historical measurement data collected by this sensor S_{M+1} that has been recorded in the data table DHM stored in the data warehouse. Alternatively, the device 100 can be configured to regularly read a data registry wherein information relating to the sensor fleet of the environment ENV is stored, detect this addition and obtain the associated information it will need to perform supervision operations on AI models put into production in the environment ENV.

In step E20, the information obtained is used to check that the measurement data history associated with the additional sensor S_{M+1} comprises sufficient data to be integrated into the system PTF, based on one or more conditions specified in the governance file GVP. For example, they are stored in the “data_acquisition” section. In FIG. 2, for example, for group GP₁, the requirement is three years of historical measurement data. Of course, other conditions, such as volume, frequency, etc., can be taken into account when deciding whether or not to integrate the additional sensor.

In E21, if the condition is not met, the additional sensor is not integrated into a group of sensors managed by the system PTF, and the method stops. Optionally, an event report LOG is generated in E10 and made available to an analyst U2. In this way, he will be informed that the measurement data from this sensor S_{M+1} will not be used to predict the evolution of the operation of the environment ENV and to predict possible malfunctions. This event report can also indicate the reason for rejection of the sensor S_{M+1}

On the contrary, if the condition is met in E21, a new execution of step E15, already disclosed, is triggered, during which it is determined whether or not the additional sensor S_{M+1} can be assigned to an existing sensor group GP₁ to GP_{N}. To do this, historical measurement data associated with this additional data sensor S_{M+1} is obtained from the data table DHM stored in the warehouse DWH.

The historical measurement data obtained is then compared with that of the reference sensors from the plurality of sensor groups GP₁ to GP_{N} currently in production in the environment. As previously described, in at least one embodiment, the similarity measurement used to perform this comparison is the one specified in memory for each group, for example, in the governance file GVP. It is assumed, for example, that the sensor S_{M+1} is assigned to the group for which the similarity measurement is greatest, the difference is smallest, respectively, while respecting the threshold condition specified in the governance file GVP.

In E16, if a group has been found, the method proceeds to step E10 to generate an event report LOG. Otherwise, step E17 to create an additional group GP_{N+1} is performed. In this case, the sensor S_{M+1} is the only member of the group and automatically becomes its reference sensor.

In E18, training of a new AI model MD_{N+1} is triggered at the module TRN, using training and test sets consisting of part of the measurement data history of the new sensor S_{M+1}. Once training is complete, the new AI model is evaluated in E8 using an evaluation set, which, according to one or more embodiments, can be made up of another part of the measurement data history of the new sensor S_{M+1}.

In E9, the new AI model is deployed in the real environment ENV.

An event report LOG is generated in E10. Finally, an update of the governance file GVP is triggered in E11 by the update agent UPD. This update in particular consists in specifying information about adding the additional sensor to an existing group, or adding a new group comprising the additional sensor.

The steps just disclosed allow an additional data sensor to be taken into account for monitoring the environment ENV. They help to determine whether the sensor in question has a data history that satisfies sufficient predetermined conditions, particularly in terms of age, to be taken into account, and whether it can be integrated into an existing sensor group, with a new group created specifically for it if necessary. In this way, the evolution of the resources deployed to supervise the environment ENV is taken into account to keep the AI model management system PTF up to date.

Each function, block, step described may be implemented in hardware, software, firmware, middleware, microcode or any suitable combination thereof. If they are implemented in software, the functions or blocks of the block diagrams and flowcharts can be implemented by computer program instructions/software codes, which can be stored or transmitted on a computer-readable medium, or loaded onto a general-purpose computer, special-purpose computer or other programmable processing device and/or system, so that the computer program instructions or software codes running on the computer or other programmable processing device create the means to implement the functions described herein.

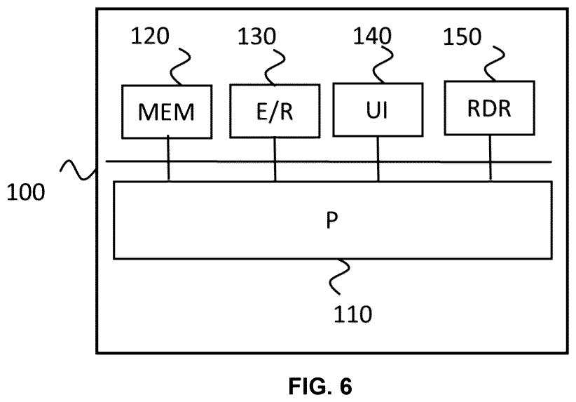

FIG. 6 shows an example of the hardware structure of a device 100 for managing artificial intelligence models previously trained to predict data sensor measurements for a next time period, based on measurement data collected for a previous time period, according to one or more embodiments. In this example, the device 100 is configured to implement all the steps of the method disclosed herein by way of one or more embodiments. Alternatively, in at least one embodiment, it could also implement only some of these steps.

In relation to FIG. 6, in at least one embodiment, the device 100 comprises at least one processor 110 and at least one memory 120. The device 100 may also comprise one or more communication interfaces. In this example, the device 100 comprises network interfaces 130 (for example, network interfaces for wired/wireless network access, including an Ethernet interface, a WIFI interface, etc.) connected to the processor 110 and configured to communicate via one or more wired/wireless communication links and user interfaces 140 (for example, a keyboard, a mouse, a display screen, etc.) connected to the processor. The device 100 may also comprise one or more media players 150 for reading a computer-readable storage medium (for example, a digital storage disk (CD-ROM, DVD, Blue Ray, etc.), a USB stick, etc.). The processor 110 is connected to each of the other aforementioned components in order to control the operation thereof.

The memory 120 may comprise a random-access memory (RAM), cache memory, non-volatile memory, backup memory (for example, programmable or flash memories), read-only memory (ROM), a hard disk drive (HDD), a solid-state drive (SSD) or any combination thereof. The ROM of the memory 120 can be configured to store, inter alia, an operating system of the device 100 and/or one or more computer program codes of one or more software applications. The RAM of the memory 120 can be used by the processor 110 for temporary data storage.

The processor 110 can be configured to store, read, load, execute and/or else process instructions stored in a computer-readable storage medium and/or in the memory 120 so that, when the instructions are executed by the processor, the device 100 performs one or more or all of the steps of the management method disclosed herein. Means implementing a function or set of functions may correspond in this document to a software component, a hardware component or even a combination of hardware and/or software components, capable of implementing the function or set of functions, as described below for the means related.

The description herein, by way of one or more embodiments, also relates to an information storage medium readable by a data processor, and comprising instructions of a program as mentioned above.

The information storage medium can be any hardware means, entity or apparatus, capable of storing the instructions of a program as mentioned above. Usable program storage media include ROM or RAM, magnetic storage media such as magnetic disks and tapes, hard disks or optically readable digital data storage media, or any combination thereof.

In some cases, in at least one embodiment, the computer-readable storage medium is non-transitory. In other cases, in at least one embodiment, the information storage medium may be a transient medium (for example, a carrier wave) for transmitting a signal (electromagnetic, electrical, radio or optical signal) containing program instructions. This signal can be routed via a suitable wired or wireless transmission means: electrical or optical cable, radio or infrared link, or by other means.

At least one embodiment of the invention also relates to a computer program product comprising a computer-readable storage medium on which program instructions are stored, the program instructions being configured to cause the host device (for example a computer) to implement some or all of the steps of the method disclosed herein when the program instructions are executed by one or more processors and/or one or more programmable hardware components of the host device.

Although aspects of the disclosure have been described with reference to one or more embodiments, it should be understood that these embodiments merely shows the principles and applications of the disclosure. It is therefore understood that numerous modifications may be made to the illustrative one or more embodiments and that other arrangements may be devised without departing from the spirit and scope of the disclosure as determined on the basis of the claims and their equivalents.

The above-mentioned one or more embodiments and their variants each have numerous advantages

The system, device and method just disclosed, according to one or more embodiments of the invention, enable the automatic supervision of the operation of artificial intelligence models previously trained and put into production, each to predict the evolution of the measurements of a group of sensors among a plurality of data sensors deployed in a real environment, for example an industrial plant, with a view to preventing possible malfunctions in this environment. The methods presented here enable checking of the performance level of AI models put into production, and re-training of said AI models as soon as necessary to maintain optimum performance over time, according to one or more embodiments of the invention.

One or more embodiments of the invention also make it possible to supervise the plurality of data sensors deployed in the environment, in particular to detect a change in the statistical properties of the measurements they collect and dynamically reassign them to another group of sensors to which they have become closer. One or more embodiments of the invention also make it possible to integrate a new data sensor into the system.

Finally, one or more embodiments of the invention enable dynamic updating of the system by updating a governance computer file created to specify the groups of sensors and their associated AI model, the data tables comprising the history of measurement data collected by the sensors and that comprising the history of measurement predictions produced by the AI models, and/or the operational parameters that the system must use to function. In this way, in at least one embodiment, the addition of a sensor, a group of sensors, an AI model or a version of this model, changes in conditions and rules to be applied, etc., are reflected in the system, without the need to modify the application source code. Another advantage, in at least one embodiment, is considerable time savings and greater responsiveness.

Advantages and solutions to problems have been described above with regard to specific one or more embodiments of the invention. However, advantages, benefits, solutions to problems, and any element which may cause or result in such advantages, benefits or solutions, or cause such advantages, benefits or solutions to become more pronounced shall not be construed as a critical, required, or essential feature or element of any or all of the claims.

1-14. (canceled)

15. A computer-implemented method of managing artificial intelligence models previously trained to predict an evolution of measurements of a plurality of data sensors and deployed in an industrial environment to monitor its operation, the plurality of data sensors being divided into multiple groups, wherein sensors of one group of sensors of said multiple groups being configured to measure a same given physical property among at least a water level, a pressure, a temperature and a depth, an artificial intelligence model being deployed in the industrial environment in association with said one group of sensors, said computer-implemented method implemented within a computer system and comprising:
obtaining measurements collected during a given time period by a reference sensor of said one group of sensors of a plurality of sensors placed in said industrial environment,
comparing predictions of measurements of said reference sensor for the given time period, produced by said artificial intelligence model associated with said one group of sensors, with said measurements obtained for said reference sensor, using a first distance metric;
when a distance obtained from said first distance metric is greater than a first given threshold, selecting a new reference sensor for said one group of sensors from among other sensors in the one group of sensors, the new reference sensor that is selected being associated with a smaller distance between the predictions of the artificial intelligence model and the measurements collected for the given time period,
re-training said artificial intelligence model, as a re-trained artificial intelligence model, from at least one training set formed from historical measurement data of the new reference sensor stored in a measurement data table and historical measurement predictions stored in a prediction data table,
evaluating said artificial intelligence model using an evaluation set comprising at least some of said measurements that are obtained, for which the distance that is obtained is greater than said first given threshold, the evaluating comprising
determining a performance score for the artificial intelligence model re-trained with the evaluation set,
comparing the performance score with an initial performance score obtained by the artificial intelligence model before said re-training, and
deciding that the evaluating is successful, when the performance score of the re-trained artificial intelligence model is greater than or equal to that of the initial performance score; and
in an event of a successful evaluation, making the re-trained artificial intelligence model available to deploy in the industrial environment to replace the artificial intelligence model associated with said one group of sensors.

16. The computer-implemented method according to claim 15, further comprising,
obtaining, from the measurement data table, measurements collected by the reference sensor of said one group of sensors of said plurality of data sensors, for a first distinct time period and a second distinct time period;
comparing the measurements that are collected by said reference sensor for the first distinct time period and the second distinct time period using a second distance metric;
when the distance that is obtained is greater than a second given threshold, selecting another new reference sensor for said one group of sensors, the another new reference sensor that is selected being associated with a smaller distance between the measurements collected for the first distinct time period and the second distinct time period,
re-training said artificial intelligence model from at least one training set comprising at least part of data of a measurement data history collected by the another new reference sensor stored in said measurement data table and changing said reference sensor of said one group of sensors,
searching for another group of sensors of said multiple groups to which to assign said reference sensor, depending on a distance between data collected by a reference sensor associated with said another group and that collected by said reference sensor, and when said distance is less than a third given threshold, assigning said reference sensor to said another group.

17. The computer-implemented method according to claim 16, further comprising,
when said distance is greater than or equal to said third given threshold, creating a new group of data sensors comprising said reference sensor, and training a new artificial intelligence model associated with the new group of sensors from at least one training set comprising at least part of the data of a measurement data history collected by the reference sensor, stored in said measurement data table,
once said new artificial intelligence model has been trained, evaluating the new artificial intelligence model using an evaluation set comprising at least some of said measurements that are obtained, for which the distance that is obtained is greater than said second given threshold;
in an event of a successful evaluation, deploying said new artificial intelligence model in the industrial environment.

18. The computer-implemented method according to claim 17, wherein the evaluating of the new artificial intelligence model comprises,
determining a performance score for the new artificial intelligence model in the evaluation set,
comparing the performance score for the new artificial intelligence model with the performance score of the artificial intelligence model of said one group of sensors that already exists, and
deciding that the evaluating is successful, when the performance score of the new artificial intelligence model is greater than or equal to that of the performance score of the artificial intelligence model that already exists.

19. The computer-implemented method according to the claim 15, further comprising,
obtaining information relating to addition of a new data sensor in said industrial environment, comprising a history of measurements collected by said new data sensor,
searching for another group of sensors among said multiple groups, to which to assign the new data sensor, depending on a distance between data collected by said reference sensor associated with said one group of sensors and data collected by said new data sensor,
when said distance is less than a given third threshold, assigning said new data sensor to said another group of sensors, and
when said distance is greater than or equal to said third given threshold, creating a new group of data sensors comprising said new data sensor as a reference sensor,
training a new artificial intelligence model associated with the new group of data sensors;
once said new artificial intelligence model has been trained, evaluating the new artificial intelligence model using an evaluation set comprising at least some of said measurements that are obtained, for which the distance that is obtained is greater than said second given threshold;
in an event of a successful evaluation, deploying said new artificial intelligence model in the industrial environment.

20. The computer-implemented method according to claim 15, further comprising reading a governance computer file, stored in memory, describing for said multiple groups, artificial intelligence models that are associated with said multiple groups, the reference sensor and operational parameters that control operations performed during implementation of said computer-implemented method.

21. The computer-implemented method according to claim 20, further comprising updating the governance computer file when changes have been made to said multiple groups.

22. The computer-implemented method according to claim 15, further comprising generating an event report comprising information relating to operations performed during implementation of said computer-implemented method and making said event report available.

23. The computer-implemented method according to claim 15, wherein said computer-implemented method is implemented within said computer system that comprises a non-volatile computer-readable recording medium, on which a computer program is recorded, the computer program comprising instructions which, when they are executed by a processor, implement the computer-implemented method.

24. A device that manages artificial intelligence models previously trained to predict an evolution of measurements of a plurality of data sensors deployed in an industrial environment to monitor its operation, the plurality of data sensors being divided into multiple groups, sensors of one group of sensors of said multiple groups being configured to measure a same given physical property among at least a water level, a pressure, a temperature and a depth, wherein an artificial intelligence model is deployed in the industrial environment in association with said one group of sensors, said device being configured to implement, within a computer system:
obtaining measurements collected during a given time period by a reference sensor of a group of data sensors of a plurality of sensors from said multiple groups placed in said industrial environment,
comparing predictions of measurements of said reference sensor for the given time period, produced by said artificial intelligence model associated with said group of data sensors, with measurements obtained for said reference sensor, using a first distance metric,
when a distance obtained from said first distance metric is greater than a first given threshold, selecting a new reference sensor for said group of data sensors from among other sensors in the group of data sensors, the new reference sensor that is selected being associated with a smaller distance between the predictions of measurements of the artificial intelligence model and the measurements that are collected for the given time period,
re-training said artificial intelligence model, as a re-trained artificial intelligence model, from at least one training set formed from historical measurement data of the new reference sensor stored in a measurement data table and historical measurement predictions stored in a prediction data table,
evaluating said re-trained artificial intelligence model using an evaluation set comprising at least some of said measurements that are obtained, for which the distance that is obtained is greater than said first given threshold, the evaluating comprising
determining a performance score for the re-trained artificial intelligence model that is re-trained with the evaluation set,
comparing the performance score with an initial performance score obtained by the artificial intelligence model before said re-training, and
deciding that the evaluating is successful, when the performance score of the re-trained artificial intelligence model is greater than or equal to that of the initial performance score; and
in an event of a successful evaluation, making the re-trained artificial intelligence model available to deploy in the industrial environment to replace the artificial intelligence model associated with said one group of sensors.

25. The device according to claim 24, further comprising
at least one processor; and
at least one memory comprising computer program code, the at least one memory and the computer program code being configured to, together with the at least one processor, cause said device to be run.

26. A computer system for managing prediction models, comprising:
a device that manages artificial intelligence models previously trained to predict an evolution of measurements of a plurality of data sensors deployed in an industrial environment to monitor its operation, the plurality of data sensors being divided into multiple groups, sensors of one group of sensors of said multiple groups being configured to measure a same given physical property among at least a water level, a pressure, a temperature and a depth, wherein an artificial intelligence model is deployed in the industrial environment in association with said one group of sensors, said device being configured to implement, within a computer system, a computer-implemented method comprising
obtaining measurements collected during a given time period by a reference sensor of a group of data sensors of a plurality of sensors from said multiple groups placed in said industrial environment,
comparing predictions of measurements of said reference sensor for the given time period, produced by said artificial intelligence model associated with said group of data sensors, with measurements obtained for said reference sensor, using a first distance metric,
when a distance obtained from said first distance metric is greater than a first given threshold, selecting a new reference sensor for said group of data sensors from among other sensors in the group of data sensors, the new reference sensor that is selected being associated with a smaller distance between the predictions of measurements of the artificial intelligence model and the measurements that are collected for the given time period,
re-training said artificial intelligence model, as a re-trained artificial intelligence model, from at least one training set formed from historical measurement data of the new reference sensor stored in a measurement data table and historical measurement predictions stored in a prediction data table,
evaluating said re-trained artificial intelligence model using an evaluation set comprising at least some of said measurements that are obtained, for which the distance that is obtained is greater than said first given threshold, the evaluating comprising
determining a performance score for the re-trained artificial intelligence model that is re-trained with the evaluation set,
comparing the performance score with an initial performance score obtained by the artificial intelligence model before said re-training, and
deciding that the evaluating is successful, when the performance score of the re-trained artificial intelligence model is greater than or equal to that of the initial performance score; and
in an event of a successful evaluation, making the re-trained artificial intelligence model available to deploy in the industrial environment to replace the artificial intelligence model associated with said one group of sensors;
at least one data registry storing artificial intelligence models previously trained to predict data sensor measurements for a next time period, based on data collected for a previous time period,
at least one data warehouse comprising said measurement data table, comprising a history of measurement data collected by the data sensors, and said prediction data table comprising a history of predictions of sensor measurements by said artificial intelligence models,
at least one memory storing a governance computer file describing the multiple groups, and for said one group of sensors, the artificial intelligence model, the measurement data table and operational parameters that control operations performed by said device.
